(19) United States
(12) Patent Application Publication
(10) Pub. No.: US 2004/0217218 A1
(43) Pub. Date: Nov. 4, 2004

(54) Saturation characteristics of electrostatic spray gun transformer

(76) Inventors: Craig P Healy, Wyoming, MN (US); Lawrence J Lunzer, St Louis Park, MN (US)

Correspondence Address: Douglas B Farrow, Graco Minnesota Inc, Intellectual Property Counsel, P O Box 1441, Minneapolis, MN, 55440-1441, US

(21) Appl. No.: 10/487,736

(22) PCT Filed: Sep. 6, 2002
(86) PCT No.: PCT/US02/28454

Related U.S. Application Data
(60) Provisional application No. 60/317,864, filed on Sep. 6, 2001.

(51) Int. Cl. B05B 5/00

(52) U.S. Cl. 239/690

(57) ABSTRACT

The transformer (16) in the power supply (14) of an electrostatic spray gun (12) is designed to start saturating before the maximum desired output current is reached. During saturation, as the transformer secondary current goes up, the output voltage goes down, thus obtaining the desired output load line with much less tip resistance. Since the transformer (16) was designed to saturate earlier, it was also smaller in size. This reduced overall size and weight of the gun (12) compared to prior art power supplies have larger transformers and tip resistors.

### TECHNICAL FIELD

This application claims the benefit of U.S. Application serial No. 60/317,864, filed Sep. 6, 2001.

### BACKGROUND ART

Electrostatic spray guns have proven to be useful tools for efficient application of paints and coatings. Compared to non-electrostatic guns, such tools have proven relatively heavy and bulky. Any advances which serve to reduce weight and/or size have been well received.

### DISCLOSURE OF THE INVENTION

To save critical space in a hand held electrostatic gun, a transformer was designed to saturate at a level that allowed reducing the size of the transformer as well as the value of the current limiting resistors.

In an electrostatic power supply a transformer is used to step up the voltage to feed the voltage multiplier. In the past this transformer was designed to saturate well above the maximum gun operating point. Large value tip resistors would then be used to obtain the desired output load line (inverse linear relationship between tip voltage and current).

The transformer of the instant invention is designed to start saturating before the maximum desired output current is reached. During saturation, as the transformer secondary current goes up, the output voltage goes down, thus obtaining the desired output load line with much less tip resistance. Since the transformer was designed to saturate earlier, it was also smaller in size. This reduced overall size and weight of the gun compared to prior art power supplies have larger transformers and tip resistors.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a top partial cross-section of the power supply utilizing the instant invention.

FIG. 2 is a side cross-section of the power supply utilizing the instant invention.

FIG. 3 is an end cross-section of the power supply utilizing the instant invention.

FIG. 4 is a multiplier schematic utilizing the instant invention.

FIG. 5 is a circuit board schematic utilizing the instant invention.

FIG. 6 is a parts list for the schematic of FIG. 5.

FIG. 7 is a partial cutaway of the transformer of the instant invention.

FIG. 8 is a schematic of the transformer of the instant invention.

FIGS. 9a and 9b show the primary of the transformer of the instant invention.

FIG. 10 shows the core of the transformer of the instant invention.

FIGS. 11a and 11b show the chassis of the transformer of the instant invention.

FIG. 12 shows the power supply in a spray gun

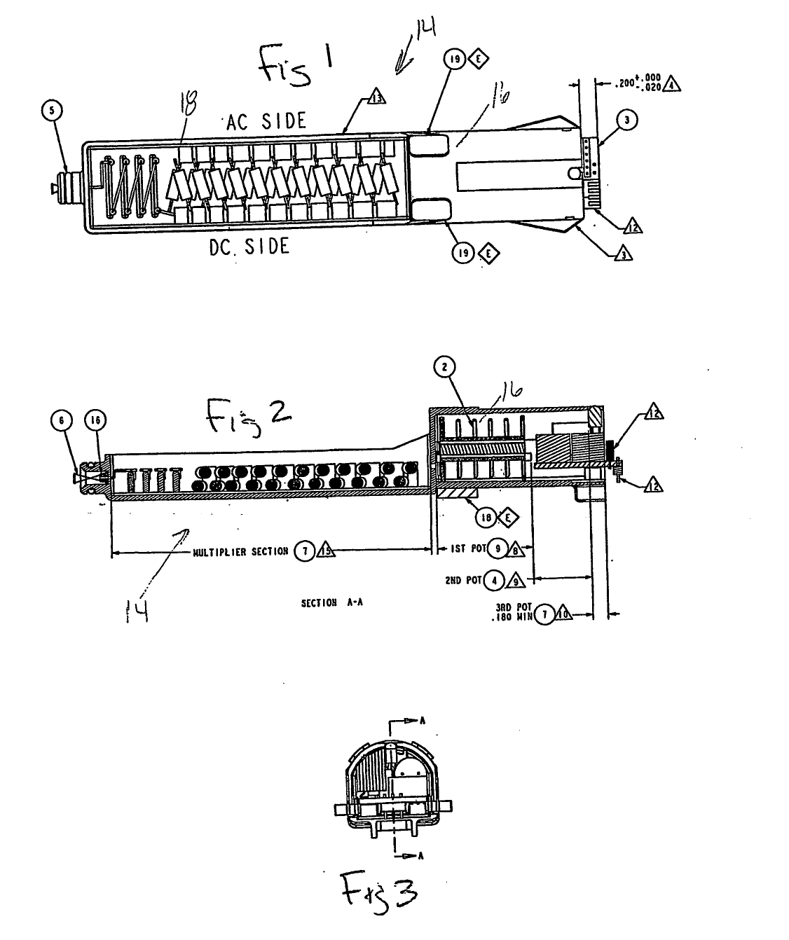

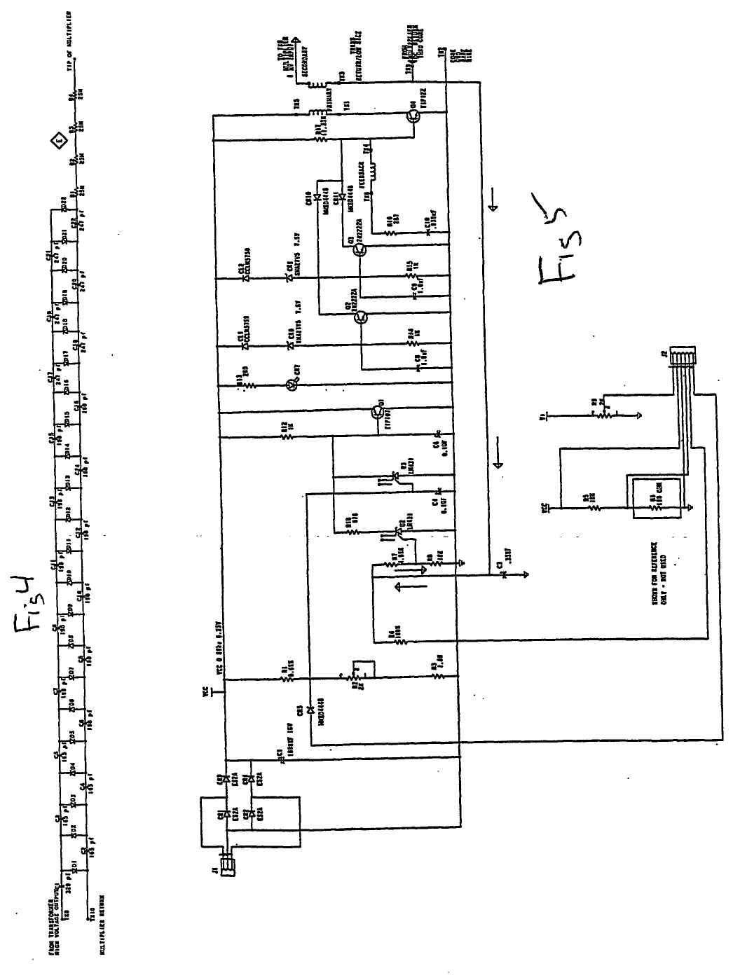

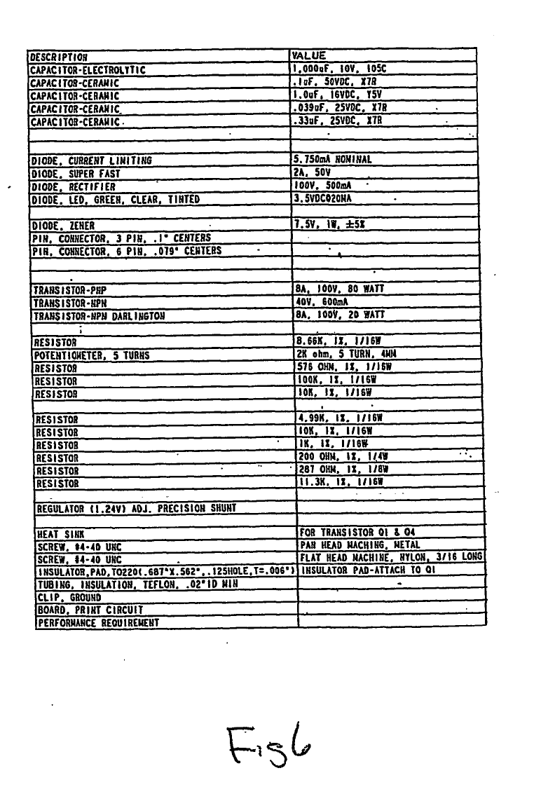

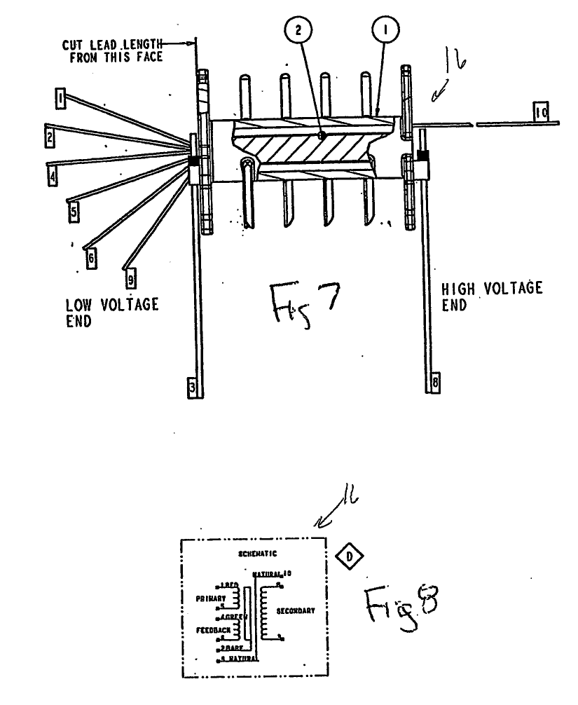

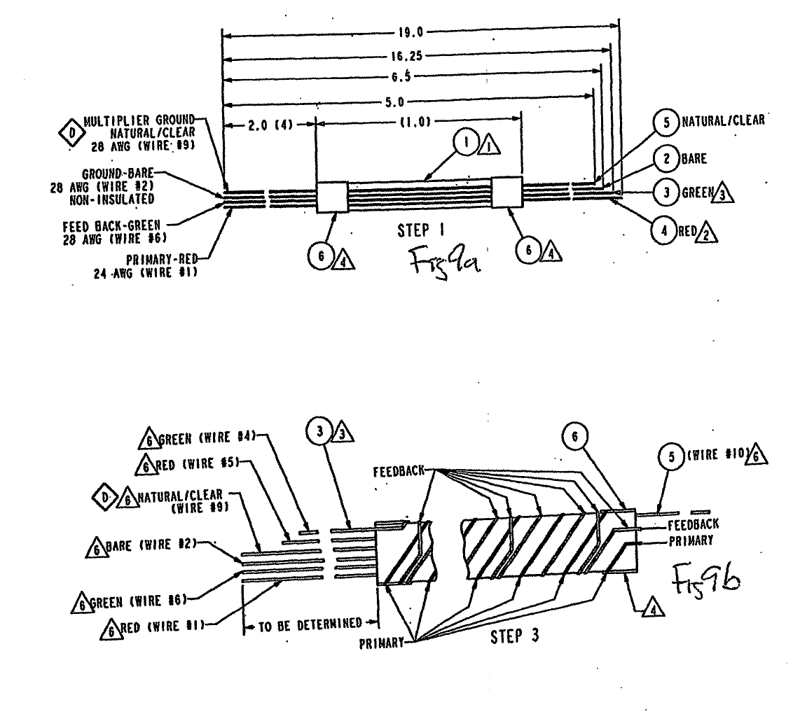

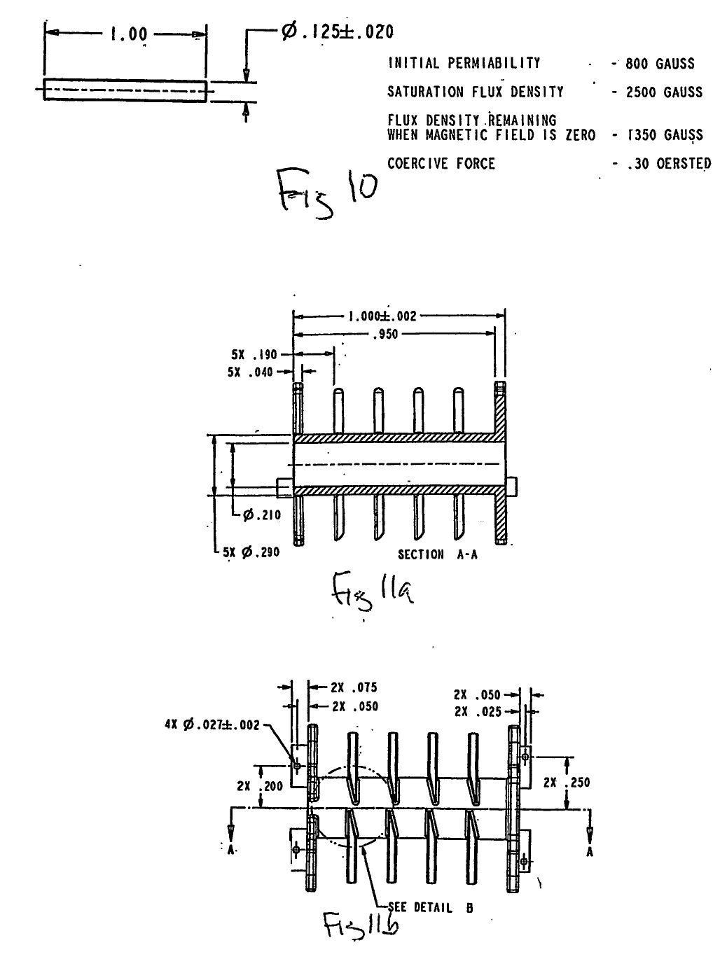

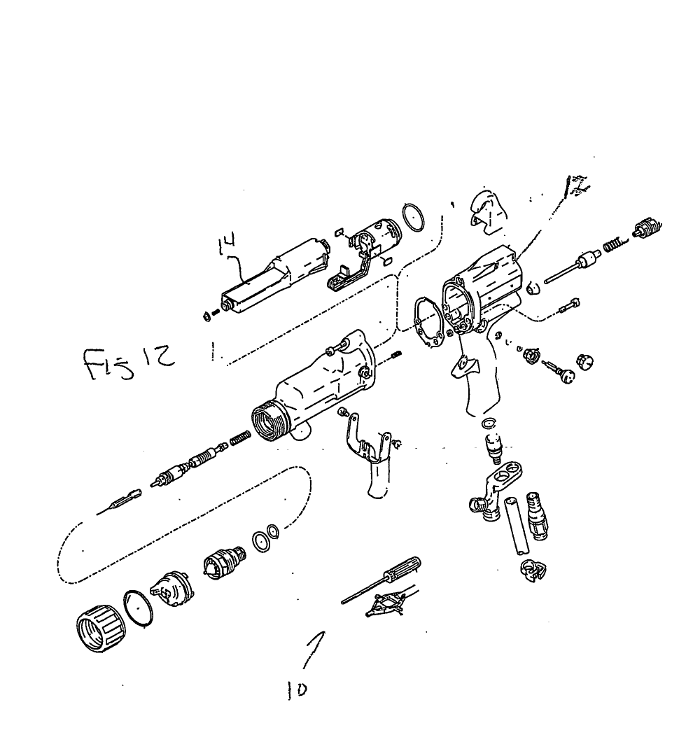

### BEST MODE FOR CARRYING OUT THE INVENTION

In the spray gun 12 of the instant invention, generally designated 10, an electrostatic power supply 14 has a transformer 16 that is used to step up the voltage to feed the voltage multiplier 18. The transformer 16 of the instant invention is designed to start saturating before the maximum desired output current is reached. During saturation, as the transformer secondary current goes up, the output voltage goes down, thus obtaining the desired output load line with much less tip resistance. Since the transformer was designed to saturate earlier, it was also smaller in size.

It is contemplated that various changes and modifications may be made to the power supply without departing from the spirit and scope of the invention as defined by the following claims.

1. In an electrostatic spray gun having a power supply with a transformer and a multiplier and a maximum output current, the improvement comprising said transformer being designed to start saturating before said maximum output current is reached.
